(19) United States
(12) Patent Application Publication
(10) Pub. No.: US 2024/0064217 A1
(43) Pub. Date: Feb. 22, 2024

(54) Timing Control Management Method and Timing Control Management System Capable of Adjusting Reordering Timer

(71) Applicant: MEDIATEK INC., Hsin-Chu (TW)

(72) Inventors: Yi-Ting Cheng, Hsinchu City (TW); Yu-Hao Hsieh, Hsinchu City (TW)

(73) Assignee: MEDIATEK INC., Hsin-Chu (TW)

(21) Appl. No.: 18/204,957

(22) Filed: Jun. 2, 2023

Related U.S. Application Data
(60) Provisional application No. 63/399,227, filed on Aug. 19, 2022.

(51) Int. Cl. H04L 69/28; H04L 65/65

(52) U.S. Cl. CPC H04L 69/28; H04L 65/65

(57) ABSTRACT

A timing control management method includes receiving a real-time protocol (RTP) packet by a jitter buffer management module, generating a playout delay range according to the RTP packet, transmitting the playout delay range to a reordering timer management module, generating a timer adjustment command from the reordering timer management module to a transport layer reordering function module, and adjusting a reordering timer according to the playout delay range by the transport layer reordering function module after the timer adjustment command is received by the transport layer reordering function module.

### CROSS REFERENCE TO RELATED APPLICATIONS

This application claims the benefit of U.S. Provisional Application No. 63/399,227, filed on Aug. 19, 2022. The content of the application is incorporated herein by reference.

### BACKGROUND

With the rapid development of science and technology, various voice over internet protocol (VoIP) applications are adopted in our daily life. Generally, VoIP systems can perform a voice sharing function and a voice broadcasting function under a wireless channel. Since the interference of the wireless channel or a power saving technology (i.e., such as discontinuous reception, DRX technology) is introduced to the VoIP systems, a real-time protocol (RTP) voice layer of the VoIP systems may receive voice packets with irregular periods. This causes a jitter peak effect, leading to a deteriorated user's auditory experience.

Currently, in the VoIP systems, a playout delay is introduced and can be adjusted by a jitter buffer management according to RTP sequence numbers. Further, a reordering timer is introduced to the transmission layer. A goal of introducing the playout delay and the reordering timer is to increase the video fluency and improve user's auditory experience. However, when the playout delay mismatches the reordering timer, the voice latency may be increased, worsening the user's auditory experience.

Therefore, to develop a timing control management method for the VoIP systems is an important design issue.

### SUMMARY

In an embodiment of the present invention, a timing control management method is disclosed. The timing control management method comprises receiving a real-time protocol (RTP) packet by a jitter buffer management (JBM) module, generating a playout delay range according to the RTP packet, transmitting the playout delay range to a reordering timer management module, generating a timer adjustment command from the reordering timer management module to a transport layer reordering function module, and adjusting a reordering timer according to the playout delay range by the transport layer reordering function module after the timer adjustment command is received by the transport layer reordering function module.

In another embodiment of the present invention, a timing control management system is disclosed. The timing control management system comprises a jitter buffer management (JBM) module, a transport layer reordering function module, and a reordering timer management module. The JBM module is configured to receive a real-time protocol (RTP) packet. The transport layer reordering function module is coupled to the JBM module and the transport layer reordering function module and is configured to communicate with the JBM module and the transport layer reordering function module. After the RTP packet is received by the JBM module, the JBM module generates a playout delay range according to the RTP packet. The JBM module transmits the playout delay range to the reordering timer management module. The reordering timer management module generates a timer adjustment command to the transport layer reordering function module. The transport layer reordering function module adjusts a reordering timer according to the playout delay range after the timer adjustment command is received by the transport layer reordering function module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a timing control management system according to an embodiment of the present invention.

FIG. 2 is a flow chart of adjusting the reordering timer according to the playout delay range of the timing control management system in FIG. 1.

FIG. 3 is a flow chart of performing the timing control management method by the timing control management system in FIG. 1.

### DETAILED DESCRIPTION

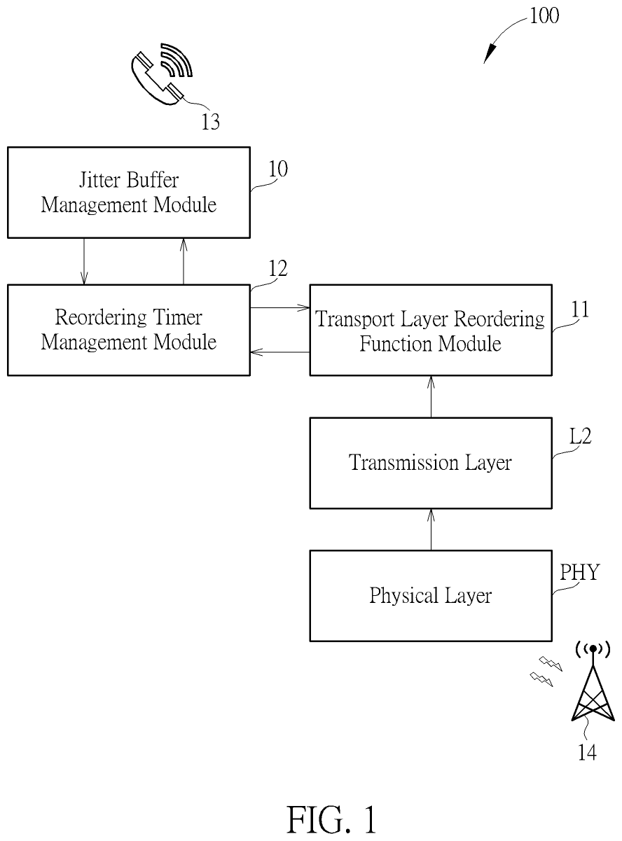

FIG. 1 is a block diagram of a timing control management system 100 according to an embodiment of the present invention. The timing control management system 100 can be applied to a voice over internet protocol (VoIP) system. For example, the timing control management system 100 can be applied to a voice over long term evolution (VoLTE) system or a voice over new radio (VoNR) system. The timing control management system 100 includes a jitter buffer management (JBM) module 10, a transport layer reordering function module 11, and a reordering timer management module 12. The JBM module 10 is used for receiving a real-time protocol (RTP) packet. The transport layer reordering function module 11 is used for adjusting a reordering timer. The reordering timer management module 12 is coupled to the JBM module 10 and the transport layer reordering function module 11 for communicating with the JBM module 10 and the transport layer reordering function module 11. In the timing control management system 100, after the RTP packet is received by the JBM module 10, the JBM module 10 can generate a playout delay range according to the RTP packet. For example, after the RTP packet is received by the JBM module 10, the JBM module 10 can dynamically adjust the playout delay range according to receiving statuses of RTP sequence numbers. Then, the JBM module 10 can transmit the playout delay range to the transport layer reordering function module 11 through the reordering timer management module 12. The reordering timer management module 12 can generate a timer adjustment command to the transport layer reordering function module 11. Then, after the timer adjustment command is received by the transport layer reordering function module 11, the transport layer reordering function module 11 can adjust a reordering timer according to the playout delay range.

In the timing control management system 100, the playout delay range and the reordering timer are introduced. Particularly, as previously mentioned, the JBM module 10 can dynamically adjust the playout delay range according to receiving statuses of RTP sequence numbers. The reordering timer is initially determined according to a communication protocol or a network configuration. Further, the playout delay range is relevant to the buffering time of the RTP packet. For example, a minimum playout delay of the playout delay range is a minimum buffering time length of the RTP packet. A maximum playout delay of the playout delay range is a maximum buffering time length of the RTP packet. Since the playout delay range of the RTP packet is introduced, latency of the VoIP commutations can be reduced. Further, the reordering timer can be regarded as a waiting time for re-allocating a packet sequence processed by an automatic repeat-request (ARQ) and/or hybrid automatic repeat-request (HARQ). For example, the reordering timer of a radio link control (RLC) module of a long term evolution (LTE) protocol (4G) can be regarded as the waiting time for re-allocating the packet sequence processed by the HARQ in the media access control (MAC) layer. The reordering timer of a packet data convergence protocol (PDCP) module of a new radio (NR) protocol (5G) can be regarded as the waiting time for re-allocating the packet sequence processed by the ARQ of the RLC layer and HARQ of the MAC layer. Further, the transport layer reordering function module 11 can be the RLC module of the LTE protocol. The transport layer reordering function module 11 can be the PDCP module of the NR protocol. However, the timing control management system 100 is not limited to 4G and 5G communication applications. Any timing control for wireless communication protocol (i.e., such as Wi-Fi protocol) falls into the scope of the present invention. In FIG. 1, for downlink communications, a data signal can be generated by a base station 14. After the data signal is processed by a physical layer PHY, a transmission layer L2, the transport layer reordering function module 11, the reordering timer management module 12, and the JBM module 10, the data signal can be transmitted from the base station 14 to a speaker 13. In the timing control management system 100, the reordering timer can be adjusted according to the playout delay range. Details are illustrated later.

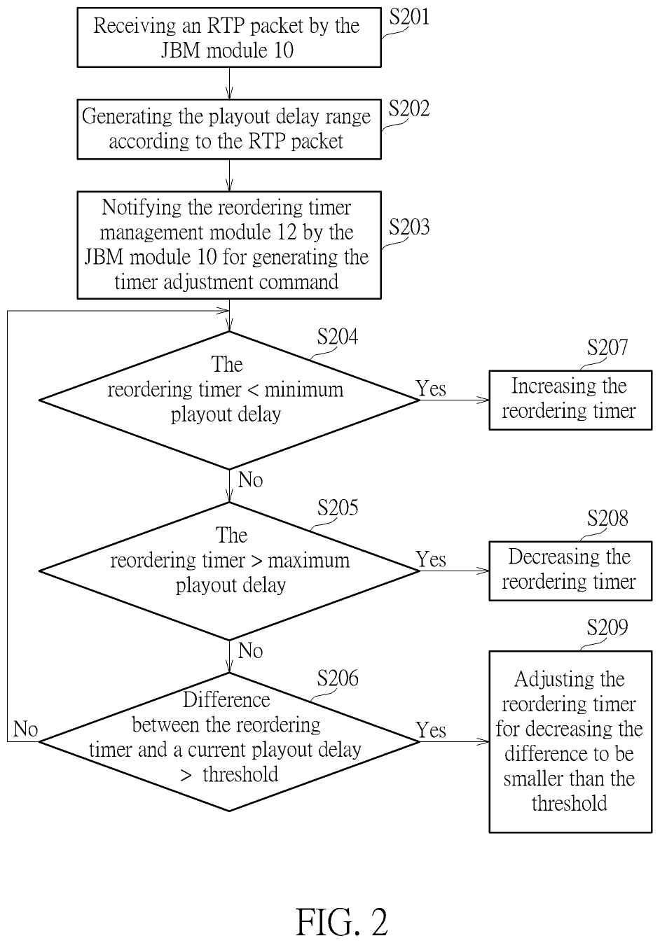

FIG. 2 is a flow chart of adjusting the reordering timer according to the playout delay range of the timing control management system 100. The reordering timer can be adjusted according to step S201 to step S209. Any reasonable technology modification falls into the scope of the present invention. Step S201 to step S209 are illustrated below.
step S201: receiving the RTP packet by the JBM module 10;
step S202: generating the playout delay range according to the RTP packet;
step S203: notifying the reordering timer management module 12 by the JBM module 10 for generating the timer adjustment command;
step S204: comparing the reordering timer with the playout delay range; If the reordering timer is shorter than a minimum playout delay, enter step S207, else, enter step S205;
step S205: comparing the reordering timer with the playout delay range; If the reordering timer is longer than a maximum playout delay, enter step S208, else, enter step S206;
step S206: determining a difference between the reordering timer and a current playout delay, if the difference is larger than a threshold, enter step S209, else, enter step S204 for processing the next reordering timer.
step S207: increasing the reordering timer.
step S208: decreasing the reordering timer.
step S209: adjusting the reordering timer for decreasing the difference to be smaller than the threshold.

In step S201, the RTP packet is received by the JBM module 10. Then, in step S202, the JBM module 10 can generate the playout delay range according to the RTP packet. The playout delay range is relevant to the buffering time of the RTP packet. For example, a minimum playout delay of the playout delay range is a minimum buffering time length of the RTP packet buffered in a jitter buffer. A maximum playout delay of the playout delay range is a maximum buffering time length of the RTP packet buffered in the jitter buffer. In step S203, the JBM module 10 can notify the reordering timer management module 12 for generating the timer adjustment command. In step S204, the transport layer reordering function module 11 can compare the reordering timer with the playout delay range. If the reordering timer is shorter than the minimum playout delay, then in step S207, the transport layer reordering function module 11 can increase the reordering timer for avoiding packet loss due to dropping timer expired packets. If the reordering timer is greater than or equal to the minimum playout delay, then in step S205, the transport layer reordering function module 11 can compare the reordering timer with the maximum playout delay. If the reordering timer is longer than the maximum playout delay, then in step S208, the transport layer reordering function module 11 can decrease the reordering timer for avoiding severe latency. If the reordering timer is between the minimum playout delay and the maximum playout delay, then in step S206, the transport layer reordering function module 11 can determine the difference between the reordering timer and the current playout delay. If the difference is larger than the threshold, then in step S209, the transport layer reordering function module 11 can adjust the reordering timer for decreasing the difference to be smaller than the threshold. If the difference is smaller than or equal to the threshold, the transport layer reordering function module 11 can re-enter step S204 for processing the next reordering timer. Here, the difference can be set to 20% current playout delay, but is not limited thereto. Briefly, the JBM module 10 can transmit a minimum playout delay, a maximum playout delay, and a current delay of the playout delay range to the transport layer reordering function module 11 through the reordering timer management module 12. Further, the transport layer reordering function module 11 can compare the minimum playout delay, the maximum playout delay, and the current delay with the reordering timer for adjusting the reordering timer. After the reordering timer is adjusted, the packet loss and severe latency can be avoided.

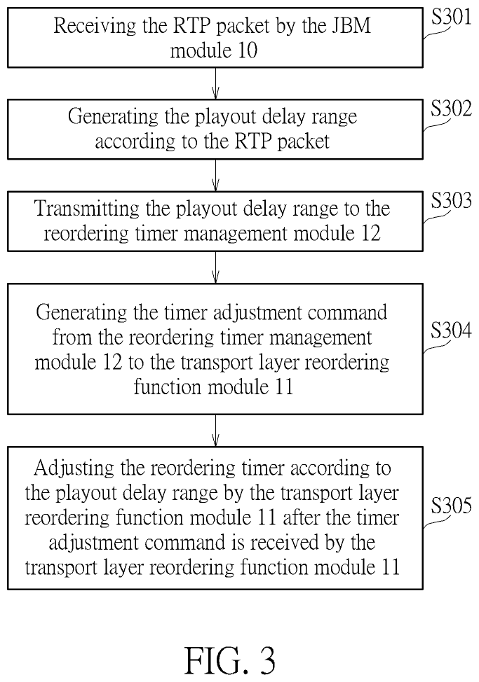

FIG. 3 is a flow chart of performing the timing control management method by the timing control management system 100. The timing control management method includes step S301 to step S305. Any reasonable technology modification falls into the scope of the present invention. Step S301 to step S305 are illustrated below.
step S301: receiving the RTP packet by the JBM module 10;
step S302: generating the playout delay range according to the RTP packet;
step S303: transmitting the playout delay range to the reordering timer management module 12;
step S304: generating the timer adjustment command from the reordering timer management module 12 to the transport layer reordering function module 11;
step S305: adjusting the reordering timer according to the playout delay range by the transport layer reordering function module 11 after the timer adjustment command is received by the transport layer reordering function module 11.

Details of step S301 to step S305 are illustrated previously. Thus, they are omitted here. In the timing control management system 100, the idea is to communicate JBM module 10 with the transport layer reordering function module 11 for appropriately adjusting the reordering timer according to the playout delay range. In one embodiment, the reordering timer is adjusted to approach the current playout delay for avoiding the packet loss and severe latency.

To sum up, the present invention discloses a timing control management method and a timing control management system. The timing control management introduces a reordering timer management module for communicating with a jitter buffer management module and a transport layer reordering function module. The jitter buffer management module determines a playout delay range. The transport layer reordering function module can adjust a reordering timer according to the playout delay range. By doing so, the packet loss and severe latency can be avoided, thereby improving user's auditory experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A timing control management method comprising:
receiving a real-time protocol (RTP) packet by a jitter buffer management (JBM) module;
generating a playout delay range according to the RTP packet;
transmitting the playout delay range to a reordering timer management module;
generating a timer adjustment command from the reordering timer management module to a transport layer reordering function module; and
adjusting a reordering timer according to the playout delay range by the transport layer reordering function module after the timer adjustment command is received by the transport layer reordering function module.

2. The method of claim 1, wherein adjusting the reordering timer according to the playout delay range by the transport layer reordering function module comprises:
acquiring a minimum playout delay of the playout delay range; and
increasing the reordering timer when the reordering timer is shorter than the minimum playout delay.

3. The method of claim 1, wherein adjusting the reordering timer according to the playout delay range by the transport layer reordering function module comprises:
acquiring a maximum playout delay of the playout delay range; and
decreasing the reordering timer when the reordering timer is longer than the maximum playout delay.

4. The method of claim 1, wherein adjusting the reordering timer according to the playout delay range by the transport layer reordering function module comprises:
setting a threshold;
determining a difference between the reordering timer and a current playout delay; and
adjusting the reordering timer for decreasing the difference to be smaller than the threshold when the difference is larger than the threshold.

5. The method of claim 1, further comprising:
transmitting a minimum playout delay, a maximum playout delay, and a current delay of the playout delay range to the transport layer reordering function module; and
comparing the minimum playout delay, the maximum playout delay, and the current delay with the reordering timer for adjusting the reordering timer.

6. The method of claim 1, wherein the transport layer reordering function module is a radio link control (RLC) module of a long term evolution (LTE) protocol.

7. The method of claim 1, wherein the transport layer reordering function module is a packet data convergence protocol (PDCP) module of a new radio (NR) protocol.

8. The method of claim 1, wherein the playout delay range is dynamically adjusted by the JBM module after the RTP packet is received by the JBM module, and the reordering timer is initially determined according to a communication protocol or a network configuration.

9. The method of claim 1, wherein a minimum playout delay of the playout delay range is a minimum buffering time length of the RTP packet, and a maximum playout delay of the playout delay range is a maximum buffering time length of the RTP packet.

10. The method of claim 1, wherein the reordering timer is a waiting time for re-allocating a packet sequence processed by an automatic repeat-request (ARQ) and/or hybrid automatic repeat-request (HARQ).

11. A timing control management system comprising:
a jitter buffer management (JBM) module configured to receive a real-time protocol (RTP) packet;
a transport layer reordering function module configured to adjust a reordering timer; and
a reordering timer management module coupled to the JBM module and the transport layer reordering function module and configured to communicate with the JBM module and the transport layer reordering function module;
wherein after the RTP packet is received by the JBM module, the JBM module generates a playout delay range according to the RTP packet, the JBM module transmits the playout delay range to the reordering timer management module, the reordering timer management module generates a timer adjustment command to the transport layer reordering function module, and the transport layer reordering function module adjusts a reordering timer according to the playout delay range after the timer adjustment command is received by the transport layer reordering function module.

12. The system of claim 11, wherein the transport layer reordering function module acquires a minimum playout delay of the playout delay range, and the transport layer reordering function module increases the reordering timer when the reordering timer is shorter than the minimum playout delay.

13. The system of claim 11, wherein the transport layer reordering function module acquires a maximum playout delay of the playout delay range, and the transport layer reordering function module decreases the reordering timer when the reordering timer is longer than the maximum playout delay.

14. The system of claim 11, wherein the transport layer reordering function module determines a difference between the reordering timer and a current playout delay, and the transport layer reordering function module adjusts the reordering timer for decreasing the difference to be smaller than the threshold when the difference is larger than the threshold.

15. The system of claim 11, wherein the JBM module transmits a minimum playout delay, a maximum playout delay, and a current delay of the playout delay range to the transport layer reordering function module through the reordering timer management module, and the transport layer reordering function module compares the minimum playout delay, the maximum playout delay, and the current delay with the reordering timer for adjusting the reordering timer.

16. The system of claim 11, wherein the transport layer reordering function module is a radio link control (RLC) module of a long term evolution (LTE) protocol.

17. The system of claim 11, wherein the transport layer reordering function module is a packet data convergence protocol (PDCP) module of a new radio (NR) protocol.

18. The system of claim 11, wherein the playout delay range is dynamically adjusted by the JBM module after the RTP packet is received by the JBM module, and the reordering timer is initially determined according to a communication protocol or a network configuration.

19. The system of claim 11, wherein a minimum playout delay of the playout delay range is a minimum buffering time length of the RTP packet, and a maximum playout delay of the playout delay range is a maximum buffering time length of the RTP packet.

20. The system of claim 11, wherein the reordering timer is a waiting time for re-allocating a packet sequence processed by an automatic repeat-request (ARQ) and/or hybrid automatic repeat-request (HARQ).
